(19) United States
(12) Patent Application Publication
(10) Pub. No.: US 2019/0352790 A1
(43) Pub. Date: Nov. 21, 2019

(54) TAPES AND METHODS OF USE FOR MASKING ALUMINUM SURFACES IN CHROMIC ACID ANODIZATION

(71) Applicant: 3M INNOVATIVE PROPERTIES COMPANY, St. Paul, MN (US)

(72) Inventors: Sarang V. Deodhar, Woodbury, MN (US); James J. Kobe, Newport, MN (US); Meredith A. Opatz, Hudson, WI (US); Vasav Sahni, St. Paul, MN (US); Daniel C. Munson, Maplewood, MN (US)

(21) Appl. No.: 16/474,208

(22) PCT Filed: Dec. 20, 2017
(86) PCT No.: PCT/US2017/067511

§ 371 Date: Jun. 27, 2019

Related U.S. Application Data
(60) Provisional application No. 62/440,531, filed on Dec. 30, 2016.

(51) Int. Cl. C25D 11/02; C25D 11/16; C25D 11/08; C09J 7/38; C09J 7/25

(52) U.S. Cl. CPC C25D 11/022; C25D 11/16; C25D 11/08; C09J 7/38; C09J 2467/006; C09J 7/255; C09J 2483/00; C09J 2407/00; C09J 2409/00; C09J 7/383

(57) ABSTRACT

A tape includes: a flexible backing layer having two major surfaces, wherein the backing layer has a thickness of greater than 64 micrometers and up to 200 micrometers, and one major surface of the backing layer includes a primed surface; and a rubber-based pressure sensitive adhesive layer disposed on the primed surface of the backing layer, wherein the pressure sensitive adhesive layer has a thickness of at least 7.6 micrometers (and preferably up to 25 micrometers); wherein, when disposed on an aluminum substrate, the tape displays a peel adhesion of less than 20 oz/in (219 N/m) according to a Peel Adhesion Strength Test described in the Examples Section, and a leakage distance of less than 762 micrometers according to a Chromic Acid Anodization—Leakage Distance Test described in the Examples Section. A method of anodizing an aluminum surface includes: providing a substrate having an aluminum surface; applying a tape as described herein to mask the aluminum surface and form a masked substrate; and exposing the masked substrate to an electrolyte solution including chromic acid under conditions effective to form aluminum oxide.

### BACKGROUND

Aluminum anodization is widely used in aerospace, electronics and general metal working industry, to improve corrosion and scratch resistance, paint and adhesive bonding of variety of aluminum alloys, and to obtain decorative finishes to aluminum surfaces. Anodization is an electrochemical process that converts an aluminum surface to aluminum oxide. Anodization is typically carried out by dipping aluminum parts in an electrolyte bath and applying DC voltage to produce an aluminum oxide layer on the surface of the part over time. Commonly used electrolyte baths for aerospace, military, and metal finishing include chromic acid, sulfuric acid, phosphoric acid, or boric-sulfuric acid. Choice of electrolyte, applied voltage, and process time depends upon target anodic coating weight, density of coating, and corrosion resistance.

Chromic acid anodization (CAA) is the one of the oldest and most widely used processes in the aerospace and metal finishing industries. Typically, 40 volts (V) (Type I) or 22 V (Type IB) are used in the process, although the Type I process (40 V) is the more commonly used.

Generally, during aluminum anodization of a part, some areas of the part need to be masked to prevent anodizing. These areas depend upon the end use of the part. Currently, tapes or curable liquids and lacquers are used as maskants. Current pressure sensitive adhesive tapes that include a variety of backings and adhesive types do not meet customer's need for effective masking in CAA. Most of the tapes either fall off or show very high acid leakage distance of the CAA material under the edges of the tape (e.g., greater than 0.050 inch (i.e., 1270 micrometers)) when applied on solvent-wiped or “Alk-Deox” pretreated (a commonly used cleaning process) aluminum parts.

Liquid masking is the most effective existing solution for masking a part in a CAA process. Liquid maskants show satisfactory performance showing little leakage distance (e.g., less than 0.015 inches (i.e., 381 micrometers)), depending upon the aluminum alloy. The application process of liquid maskants is lengthy (requiring up to 24 hours curing time before anodization) and messy, which can result in smearing of adjacent areas. For example, the removal of liquid maskants typically requires the use of methyl ethyl ketone. Also, the process of applying a liquid maskant versus a tape maskant is more expensive, for example, because a masking tape may be required prior to applying the liquid maskant to assist with painting a clean straight edge, and a more skilled worker would be required. Also, additional personal protection equipment may be required. These factors make the use of liquid maskants relatively expensive and less desirable compared to the use of a masking tape.

Thus, there is a need for a tape that will give good masking performance with less than 0.030 inch (762 micrometers) leakage distance on a wide variety of aluminum alloys that are anodized by various CAA processes (e.g., BAC 5019, Boeing Aircraft Corporation Standard), and is flexible, easy to handle (unlike lead or aluminum foil tapes), cuttable (e.g., by razor blade or die), and cleanly removable.

### SUMMARY

The present disclosure provides tapes, particularly masking tapes, and methods of using such tapes for anodizing aluminum surfaces in chromic acid anodization.

In one aspect, a tape includes: a flexible backing layer having two major surfaces, wherein the backing layer has a thickness of greater than 64 micrometers and up to 200 micrometers, and one major surface of the backing layer includes a primed surface; and a rubber-based pressure sensitive adhesive layer disposed on the primed surface of the backing layer, wherein the pressure sensitive adhesive layer has a thickness of at least 7.6 micrometers (and preferably up to 25 micrometers); wherein, when disposed on an aluminum substrate, the tape displays a peel adhesion of less than 20 oz/in (219 N/m) according to a Peel Adhesion Strength Test described in the Examples Section, and a leakage distance of less than 762 micrometers according to a Chromic Acid Anodization Leakage Distance Test described in the Examples Section.

In another aspect, a method of anodizing an aluminum surface is provided. The method includes: providing a substrate having an aluminum surface; applying a tape as described herein to mask the aluminum surface and form a masked substrate; and exposing the masked substrate to an electrolyte solution including chromic acid under conditions effective to form aluminum oxide.

The terms “polymer” and “polymeric material” are used interchangeably and refer to materials formed by reacting one or more monomers. These terms include homopolymers and copolymers. The polymers may be block, random, segmented, or the like.

The term “copolymer” refers to polymers containing two or more different monomeric units or segments, including terpolymers, tetrapolymers, etc.

The term “room temperature” refers to a temperature of 20° C. to 25° C.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits under certain circumstances. Other embodiments may also be preferred, however, under the same or other circumstances. Furthermore, the recitation of one or more preferred embodiments does not imply that other embodiments are not useful, and is not intended to exclude other embodiments from the scope of the disclosure.

Terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements (e.g., preventing and/or treating an affliction means preventing, treating, or both treating and preventing further afflictions).

Various sets of numerical ranges (for example, of the number of carbon atoms in a particular moiety, of the amount of a particular component, or the like) are described, and, within each set, any lower limit of a range can be paired with any upper limit of a range. Such numerical ranges also are meant to include all numbers subsumed within the range (for example, 1 to 5 includes 1, 1.5, 2, 2.75, 3, 3.80, 4, 5, and so forth).

All numbers herein are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above Summary section is not intended to describe every embodiment or every implementation of the disclosure. The detailed description that follows more particularly describes illustrative embodiments. Throughout the detailed description, guidance is provided through lists of examples, which examples can be used in various combinations. In each instance, a recited list serves only as a representative group and should not be interpreted as being an exclusive list.

### FIGURES

FIG. 1 is a tape of the present disclosure, not necessarily to scale.

### DETAILED DESCRIPTION

The present disclosure provides tapes, particularly masking tapes, and methods of using such tapes for anodizing aluminum surfaces in chromic acid anodization.

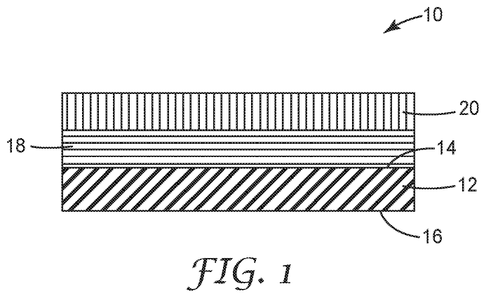

In one aspect, as shown in FIG. 1, a tape 10 includes: a flexible backing layer 12 having two major surfaces 14 and 16, wherein the backing layer 12 has a thickness of greater than 64 micrometers and up to 200 micrometers, and one major surface 14 of the backing layer 12 is a primed surface that optionally includes a chemical coating layer (i.e., a primer layer) 18; and a rubber-based pressure sensitive adhesive layer 20 disposed on the primed surface 14 or the chemical coating layer 18 (if present) of the backing layer 12, wherein the pressure sensitive adhesive layer 20 has a thickness of at least 7.6 micrometers (and preferably up to 25 micrometers).

The backing thickness and adhesive thickness, and the relationship between the two are important factors to balance in improving masking performance of the tape. That is, the proper selection of backing thickness and adhesive thickness can prevent edge lift-off of the tape from a surface (e.g., by oxygen bubbling) during anodization. Generally, leakage distance performance (i.e., leakage distance of the CAA material under the edges of the tape and the resultant anodization) decreased with increasing backing thickness; however, flexibility (allowing conformability to the profile of a product to be anodized) and handling characteristics of the tape diminished with increasing backing thickness.

A tape of the present disclosure, when disposed on an aluminum substrate, displays a peel adhesion strength of less than 50 oz/in (547 N/m), or 35 oz/in (383 N/m), or 30 oz/in (328 N/m), or even 20 oz/in (219 N/m) according to a Peel Adhesion Strength Test described in the Examples Section. Preferably, a tape of the present disclosure, when disposed on an aluminum substrate, displays a peel adhesion of less than 10 oz/in (110 N/m) according to the Peel Adhesion Strength Test. Although generally there is no minimum adhesion value, a tape of the present disclosure, when disposed on an aluminum substrate, displays a peel adhesion of at least 2 oz/in (21.9 N/m) according to the Peel Adhesion Strength Test. The specific peel adhesion strength of a tape of the present disclosure will depend, in part, on the particular adhesive used, for example silicone, natural rubber, synthetic rubber, or polyisobutylene rubber.

A tape of the present disclosure, when disposed on an aluminum substrate, displays a leakage distance of less than 0.030 inch (762 micrometers) according to a Chromic Acid Anodization—Leakage Distance Test described in the Examples Section. Preferably, a tape of the present disclosure, when disposed on an aluminum substrate, displays a leakage distance of less than 0.025 inch (635 micrometers), and even more preferably less than 0.020 inch (508 micrometers) according to the Chromic Acid Anodization—Leakage Distance Test.

A tape of the present disclosure may also be removed after anodization in one step with clean removal. In particular, in certain embodiments, a tape of the present disclosure may be removed without the need for additional solvent cleaning.

Because of such good performance with respect to adhesion, leakage distance, and removal, tapes of the present disclosure are particularly suited for use in anodizing an aluminum surface. A typical method includes: providing a substrate having an aluminum surface; applying a tape as described herein to mask the aluminum surface and form a masked substrate; and exposing the masked substrate to an electrolyte solution including chromic acid under conditions effective to form aluminum oxide. In certain embodiments, the step of exposing the masked substrate to an electrolyte solution includes immersing the masked substrate in an electrolyte bath comprising chromic acid under conditions effective to form aluminum oxide.

In certain embodiments, the method further includes cleaning the aluminum surface prior to applying the tape. In certain embodiments, cleaning the aluminum surface includes applying an alkaline deoxidation treatment (i.e., an “Alk-Deox” or “alkaline Deox” treatment). This treatment involves removal of an aluminum oxide layer formed on aluminum parts that result from corrosion or high temperature treatments of parts. A typical Alk-Deox treatment uses an acidic solution, such as nitric acid. This treatment etches away the surface oxide layer, leaving pure aluminum on the surface to anodize.

In certain embodiments, after cleaning and prior to applying the tape, the method further includes applying a conversion coating on the aluminum surface. This conversion coating assists with corrosion protection, adhesion promotion, and/or provides decorative surface. A typical conversion coating includes a trivalent or hexavalent chrome (e.g., ALODINE conversion coating from Henkel Technologies).

### Backing

A tape of the present disclosure includes a flexible backing (i.e., backing layer) having two major surfaces, wherein one major surface of the backing layer includes a primed surface.

Flexibility and the ability to be cut (e.g., with a razor blade) are important for use of the tapes of the present disclosure as maskants. For example, a tape should be sufficiently flexible to conform to the contours of a part to be anodized. As noted in the Examples Section, the flexibility of materials used as backings can be calculated using the following equation.

D=Et³/12(1−v²)

wherein D is the backing flexibility, E is the tensile or Young's Modulus of the backing, t is the backing thickness, and v is Poissons ratio of the backing material. It is desirable to have flexibility values of less than 0.00324 N-m, or 0.00096 N-m, or 0.0002075 N-m, or 0.00012 N-m, or even lower.

A typical backing layer has a thickness of greater than 64 micrometers, greater than 65 micrometers, greater than 66 micrometers, greater than 67 micrometer, greater than 68 micrometers, greater than 69 micrometers, at least 70 micrometers, or at least 75 micrometers.

In certain embodiments, the backing layer has a thickness of up to 200 micrometers, or up to 190 micrometers, up to 180 micrometers, up to 170 micrometers, up to 160 micrometers, up to 150 micrometers, up to 140 micrometers, up to 130 micrometers, or up to 125 micrometers.

Suitable materials for use in the backing include polyesters (such as polyethylene terephthalate and polyethylene naphthalate), polystyrene, polyolefins (such as polyethylene, polypropylene, including, e.g., monoaxially oriented polypropylene and biaxially oriented polypropylene), polytetrafluoroethylene, polyvinylfluoroethylene, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated). In certain embodiments, the backing includes polyethylene terephthalate.

In certain embodiments, the material of the backing includes one or more additives selected from a filler (such as silicon dioxide), a catalyst (such as antimony trioxide), a plasticizer, a pigment, and a combination thereof.

The primed surface of the backing typically includes a treated surface or a chemical coating layer (i.e., a primer layer), or both. If the primed surface is a treated surface, it includes, for example, a corona-treated surface, a plasma-treated surface, flame-treated surface, or an etched surface (e.g., sodium etched), or the like.

In certain embodiments, the primed surface includes a chemical coating layer. The chemical coating layer (i.e., primer layer) includes a phenolic, a polyterpene, a calcium zinc resinate, a polychloroprene, a polydiorganosiloxane, a copolymer of butadiene and acrylonitrile, or a combination thereof. In certain embodiments, the chemical coating layer includes a polychloroprene and/or a polydiorganosiloxane.

In certain embodiments, the chemical coating layer of the primed surface includes a polydiorganosiloxane gum, an M-Q resin, a crosslinker, and a catalyst. Examples of such materials are described further herein with respect to the pressure sensitive adhesive and in the Examples Section.

### Pressure Sensitive Adhesive

Suitable pressure sensitive adhesives of the tapes of the present disclosure are rubber-based pressure sensitive adhesives. Such rubber-based PSA's may include synthetic or natural rubbers. A suitable rubber-based PSA not only adheres the tape to a substrate surface, but also acts as barrier against chromic acid, and prevents masked aluminum from oxidizing.

The pressure sensitive adhesive layer typically has a thickness of at least 7.6 micrometers, and in certain embodiments, at least 10 micrometers. In certain embodiments, the pressure sensitive adhesive layer has a thickness of up to 25 micrometers, and in certain embodiments, up to 15 micrometers. This is in contrast to typical coating thicknesses for pressure sensitive adhesives in a masking tape, which are 0.001 inch (25.4 micrometers) or more.

In certain embodiments, the rubber-based pressure sensitive adhesive includes a silicone pressure sensitive adhesive. Silicone (i.e., silicone rubber) is an elastomer (rubber-like material). A typical silicone PSA contains a silicone gum with functionality (e.g., silanol groups), blended with a silicone resin (e.g., an M-Q resin) as a tackifier. A typical ratio of silicone gum to silicone resin is within a range of 1:1-1.25, although this can vary depending on the desired adhesive properties.

A typical silicone gum is a polydiorganosiloxane gum, such as polydimethylsiloxane (i.e., dimethylpolysiloxane) gum that includes (—Si(Me)₂-O—)ₘ groups (polydimethylsiloxane or PDMS groups), wherein m is an integer ranging from 10 (for 1000 g/mol MW) to 14,000 (for Millions g/mol MW), in certain embodiments from 10 to 5,000, in certain embodiments from 50 to 2,000, or in certain embodiments from 100 to 1000.

In certain embodiments, the polydiorganosiloxane gum is crosslinked with a monofunctional peroxide. Typical monofunctional peroxides include dichlorobenzoyl peroxide, benzoyl peroxide, or a combination thereof.

A silicone resin typically includes a branched, cage-like oligosiloxane structure with the general formula of RₙSiXₘO_{y}, where R is a non-reactive substituent, usually methyl (Me) or phenyl (Ph), and X is hydrogen or a functional group such as hydroxyl (OH), chlorine (Cl), or alkoxy (such as OMe). These groups are further condensed in many applications, to give highly crosslinked, insoluble polysiloxane networks. When R is methyl, the four possible functional siloxane monomeric units are described as follows: “M” stands for Me₃SiO; “D” stands for Me₂SiO₂; “T” stands for MeSiO₃; and “Q” stands for SiO₄. Common silicone resins include D and T units (D-T resins) or M and Q units (M-Q resins), however many other combinations (MDT, MTQ, QDT) can be used. Typical silicone resins used in pressure sensitive adhesives have molecular weights in the range of 1000 to 10,000. In certain embodiments of the present disclosure, the silicone resin is an M-Q resin.

In addition to a silicone resin, in certain embodiments, the silicone pressure sensitive adhesive includes a silicone oil. Such “oil” is of lower molecular weight than the gum. It acts as plasticizer and improves wet-out of the PSA on a surface. Although the silicone oil reduces peel-adhesion values, surprisingly a tape performs better than those without it. Because it reduces peel-adhesion values, a silicone oil is not typically added to a silicone PSA in a masking tape.

In certain embodiments, a silicone oil has a viscosity of less than 1000 centistokes, less than 100 centistokes, or less than 50 centistokes. Such viscosity information is typically provided by the supplier without reference to a method of measurement. Viscosity is commonly measured by the Capillary Tube Viscometer Test Method, which determines kinematic viscosity utilizing a capillary tube viscometer. In this method, an oil sample is placed into a glass capillary U-tube and the sample is drawn through the tube using suction until it reaches the start position indicated on the tube's side. The suction is then released, allowing the sample to flow back through the tube under gravity. The narrow capillary section of the tube controls the oil's flow rate. More viscous grades of oil take longer to flow than thinner grades of oil. This procedure is described in ASTM D445 and ISO 3104.

In certain embodiments, the silicone oil is a polydiorganosiloxane fluid, such as polydimethylsiloxane (i.e., dimethylpolysiloxane) fluid that includes (—Si(Me)₂-O—)ₘ groups (polydimethylsiloxane or PDMS groups), wherein m is an integer ranging from greater than 0 (for extremely low viscosity) and up to 800, in certain embodiments from 10 to 600, in certain embodiments from 40 to 400, or in certain embodiments from 45 to 300. Typically, a silicone oil does not have functionality, although this is not limiting. Representative silicone oils include, but are not limited to, trialkylsiloxy-terminated polydimethylsiloxane, polyphenylmethylsiloxane, polydialkylsiloxane, as well as copolymers of such with trialkylsiloxy-terminated species.

In certain embodiments, the rubber-based pressure sensitive adhesive includes greater than 3 wt-%, or at least 5 wt-%, or at least 8 wt-%, silicone oil, based on the total weight of the pressure sensitive adhesive. In certain embodiments, the rubber-based pressure sensitive adhesive comprises up to 25 wt-% silicone oil. The total amount of silicone oil may be the result of adding silicone oil per se or adding additives that contain silicone oil (e.g., pigment may contain silicone oil).

In certain embodiments, other synthetic rubber-based pressure sensitive adhesives may be used. For example, a synthetic rubber-based pressure sensitive adhesive may include a styrene-containing block copolymer. Examples of styrene-containing block copolymers include a styrene-isoprene-styrene (SIS) block copolymer, a styrene-butadiene-styrene (SBS) block copolymer, a styrene-ethylene-butylene-styrene (SEBS) block copolymer, or a mixture thereof. In certain embodiments, synthetic rubber-based adhesives are made by mixing SIS, SBS, and/or SEBS rubbers with a tackifier (such as a rosin tackifier or a aliphatic hydrocarbon tackifier) and optionally mineral or naphthenic oil.

In certain embodiments, the rubber-based pressure sensitive adhesive includes a natural rubber pressure sensitive adhesive. A typical natural rubber pressure sensitive adhesive includes polyisoprene and at least one tackifying resin such as a rosin material or hydrocarbon polyterpene resin.

In certain embodiments, the rubber-based pressure sensitive adhesive includes a polyisobutylene rubber pressure sensitive adhesive. A typical polyisobutylene rubber pressure sensitive adhesive includes polyisobutylene and at least one tackifying resin such as a hydrogenated hydrocarbon resin.

In certain embodiments, the rubber-based pressure sensitive adhesive includes one or more additives selected from a tackifier (such as such as an M-Q resin, phenolic resin hydrocarbon polyterpene resin, or hydrogenated hydrocarbon resin), an antioxidant (such as a polyphenol polymer), a pigment, a stabilizer (such as 2,5-di-tert-amyl-hydroquinone), a filler (such as zinc oxide), an oil (such as mineral oil), a plasticizer (such as a silicone oil), a lubricant, a wax (such as lanolin), a process aid, and a combination thereof. In certain embodiments, combinations of multiple such additives may be used. For example, in certain formulations described in the Examples Section, two tackifiers and two pigments are included in a formulation.

### Illustrative Embodiments

The following embodiments are intended to be illustrative of the present disclosure and not limiting.

Embodiment 1 is a tape comprising: a flexible backing layer having two major surfaces, wherein the backing layer has a thickness of greater than 64 micrometers and up to 200 micrometers, and one major surface of the backing layer comprise a primed surface; and a rubber-based pressure sensitive adhesive layer disposed on the primed surface of the backing layer, wherein the pressure sensitive adhesive layer has a thickness of 7.6 micrometers to 25 micrometers; wherein, when disposed on an aluminum substrate, the tape displays a peel adhesion strength of less than 50 oz/in (547 N/m) according to a Peel Adhesion Strength Test as described in the Examples Section, and a leakage distance of less than 762 micrometers according to a Chromic Acid Anodization Leakage Distance Test as described in the Examples Section.

Embodiment 1.1 is the tape of embodiment 1 wherein the tape displays a peel adhesion strength of less than 35 oz/in (383 N/m).

Embodiment 1.2 is the tape of embodiment 1 wherein the tape displays a peel adhesion strength of less than 30 oz/in (328 N/m).

Embodiment 1.3 is the tape of embodiment 1 wherein the tape displays a peel adhesion strength of less than 20 oz/in (219 N/m).

Embodiment 2 is the tape of embodiment 1 wherein, when disposed on an aluminum substrate, the tape displays a peel adhesion strength of less than 10 oz/in (110 N/m) according to the Peel Adhesion Strength Test.

Embodiment 3 is the tape of embodiment 1 or 2 wherein, when disposed on an aluminum substrate, the tape displays a leakage distance of less than 635 micrometers according to the Chromic Acid Anodization—Leakage Distance Test.

Embodiment 4 is the tape of any one of embodiments 1 through 3 wherein, when disposed on an aluminum substrate, the tape displays a peel adhesion of at least 2 oz/in (21.9 N/m) according to the Peel Adhesion Strength Test.

Embodiment 5 is the tape of any one of embodiments 1 through 4 wherein the backing has a thickness of greater than 65 micrometers, or greater than 66 micrometers, or greater than 67 micrometer, or greater than 68 micrometers, or greater than 69 micrometers, or at least 70 micrometers, at least 75 micrometers.

Embodiment 6 is the tape of any one of embodiment 1 through 5 wherein the backing has a thickness of up to 190 micrometers, up to 180 micrometers, up to 170 micrometers, up to 160 micrometers, up to 150 micrometers, up to 140 micrometers, up to 130 micrometers, or up to 125 micrometers.

Embodiment 7 is the tape of any one of embodiments 1 through 6 wherein the pressure sensitive adhesive layer has a thickness of at least 10 micrometers.

Embodiment 8 is the tape of any one of embodiments 1 through 7 wherein the pressure sensitive adhesive layer has a thickness of up to 15 micrometers.

Embodiment 9 is the tape of any of embodiments 1 through 8 wherein the backing comprises a material selected from polyesters (such as polyethylene terephthalate and polyethylene naphthalate), polystyrene, polyolefins (such as polyethylene, polypropylene, including, e.g., monoaxially oriented polypropylene and biaxially oriented polypropylene), polytetrafluoroethylene, polyvinylfluoroethylene, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated).

Embodiment 10 is the tape of embodiment 9 wherein the backing comprises polyethylene terephthalate.

Embodiment 11 is the tape of any one of embodiments 1 through 9 wherein the backing comprises one or more additives selected from a filler (such as silicon dioxide), a catalyst (such as antimony trioxide), a plasticizer, a pigment, and a combination thereof.

Embodiment 12 is the tape of any one of embodiments 1 through 11 wherein the rubber-based pressure sensitive adhesive comprises a silicone pressure sensitive adhesive.

Embodiment 13 is the tape of embodiment 12 wherein the silicone pressure sensitive adhesive comprises a silicone gum and an M-Q resin.

Embodiment 14 is the tape of embodiment 13 wherein the silicone gum comprises a polydiorganosiloxane.

Embodiment 15 is the tape of embodiment 14 wherein the polydiorganosiloxane comprises a polydimethylsiloxane gum.

Embodiment 16 is the tape of embodiment 14 or 15 wherein the polydiorganosiloxane is crosslinked with a monofunctional peroxide.

Embodiment 17 is the tape of embodiment 16 wherein the monofunctional peroxide comprises dichlorobenzoyl peroxide, benzoyl peroxide, or a combination thereof.

Embodiment 18 is the tape of any one of embodiments 12 through 17 wherein the silicone pressure sensitive adhesive comprises a silicone oil.

Embodiment 19 is the tape of embodiment 18 wherein the silicone oil has a viscosity of less than 1000 centistokes, or less than 100 centistokes, or less than 50 centistokes.

Embodiment 20 is the tape of embodiment 18 or 19 wherein the silicone oil comprises a polydiorganosiloxane fluid.

Embodiment 21 is the tape of any one of embodiments 18 through 20 wherein the rubber-based pressure sensitive adhesive comprises greater than 3 wt-%, or at least 5 wt-%, or at least 8 wt-%, silicone oil, based on the total weight of the pressure sensitive adhesive.

Embodiment 22 is the tape of any one of embodiments 18 through 21 wherein the rubber-based pressure sensitive adhesive comprises up to 25 wt-% silicone oil.

Embodiment 23 is the tape of any one of embodiments 1 through 11 wherein the rubber-based pressure sensitive adhesive comprises a natural rubber pressure sensitive adhesive.

Embodiment 24 is the tape of embodiment 23 wherein the natural rubber pressure sensitive adhesive comprises polyisoprene.

Embodiment 25 is the tape of any one of embodiments 1 through 11 wherein the rubber-based pressure sensitive adhesive comprises a synthetic rubber pressure sensitive adhesive (other than a silicone pressure sensitive adhesive).

Embodiment 26 is the tape of embodiment 25 wherein the synthetic rubber-based pressure sensitive adhesive comprises a styrene-containing block copolymer.

Embodiment 27 is the tape of embodiment 26 wherein the styrene-containing block copolymer comprises a styrene-isoprene-styrene block copolymer, a styrene-butadiene-styrene block copolymer, a styrene-ethylene-butylene-styrene block copolymer, or a combination thereof.

Embodiment 27a is the tape of embodiment of claim 1 through 11 wherein the rubber-based pressure sensitive adhesive comprises a polyisobutylene rubber.

Embodiment 28 is the tape of any one of embodiments 1 through 27 wherein the rubber-based pressure sensitive adhesive comprises one or more additives selected from a tackifier (such as an M-Q resin, phenolic resin, rosin material, cycloaliphatic hydrocarbon resin, or hydrocarbon polyterpene resin), an antioxidant (such as a polyphenol polymer), a pigment, a stabilizer (such as 2,5-di-tert-amyl-hydroquinone), a filler (such as zinc oxide), an oil (such as mineral oil), a plasticizer (such as a silicone oil), a wax (such as lanolin), a lubricant, a process aid, and a combination thereof.

Embodiment 29 is the tape of any one of embodiments 1 through 28 wherein the primed surface of the backing comprises a treated surface or a chemical coating layer, or both.

Embodiment 30 is the tape of embodiment 29 wherein the primed surface comprises a treated surface.

Embodiment 31 is the tape of embodiment 30 wherein the treated surface comprises a corona-treated surface, a plasma-treated surface, flame-treated surface, or an etched surface (e.g., sodium etched).

Embodiment 32 is the tape of any one of embodiments 29 through 31 wherein the primed surface comprises a chemical coating layer.

Embodiment 33 is the tape of embodiment 32 wherein the chemical coating layer comprises a phenolic, a polyterpene, a calcium zinc resinate, a polychloroprene, a polydiorganosiloxane, a copolymer of butadiene and acrylonitrile, or a combination thereof.

Embodiment 34 is the tape of embodiment 33 wherein the chemical coating layer comprises a polychloroprene and/or a polydiorganosiloxane.

Embodiment 35 is the tape of embodiment 34 wherein the chemical coating layer comprises a polydiorganosiloxane gum, an M-Q resin, a crosslinker, and a catalyst

Embodiment 36 is a method of anodizing an aluminum surface, the method comprising: providing a substrate having an aluminum surface; applying a tape of any one of the preceding embodiments to mask the aluminum surface and form a masked substrate; and exposing the masked substrate to an electrolyte solution comprising chromic acid under conditions effective to form aluminum oxide.

Embodiment 37 is the method of embodiment 36 wherein prior to applying the tape, the method further comprises cleaning the aluminum surface prior to applying the tape.

Embodiment 38 is the method of embodiment 37 wherein cleaning the aluminum surface comprises applying an alkaline deoxidation treatment.

Embodiment 39 is the method of embodiment 37 or 38 wherein after cleaning and prior to applying the tape, the method further comprises applying a conversion coating on the aluminum surface.

Embodiment 40 is the method of embodiment 39 wherein the conversion coating comprises a trivalent or hexavalent chrome.

Embodiment 41 is the method of any one of embodiments 36 through 40 wherein the step of exposing the masked substrate to an electrolyte solution comprises immersing the masked substrate in an electrolyte bath comprising chromic acid under conditions effective to form aluminum oxide; Embodiment 42 is a method of anodizing an aluminum surface, the method comprising: providing a substrate having an aluminum surface; applying a tape of any one of the preceding embodiments to mask the aluminum surface and form a masked substrate; and exposing the masked substrate to an electrolyte solution comprising chromic acid under conditions effective to form aluminum oxide. The tape comprises: a flexible backing layer having two major surfaces, wherein the backing layer has a thickness of greater than 64 micrometers and up to 200 micrometers, and one major surface of the backing layer comprises a primed surface; and a rubber-based pressure sensitive adhesive layer disposed on the primed surface of the backing layer, wherein the pressure sensitive adhesive layer has a thickness of at least 7.6 micrometers; wherein, when disposed on an aluminum substrate, the tape displays a peel adhesion strength of less than 50 oz/in (547 N/m) according to a Peel Adhesion Strength Test as described in the Examples Section, and a leakage distance of less than 762 micrometers according to a Chromic Acid Anodization—Leakage Distance Test as described in the Examples Section.

Embodiment 43 is the method of embodiment 42 wherein prior to applying the tape, the method further comprises cleaning the aluminum surface prior to applying the tape.

Embodiment 44 is the method of embodiment 43 wherein cleaning the aluminum surface comprises applying an alkaline deoxidation treatment.

Embodiment 45 is the method of embodiment 43 or 44 wherein after cleaning and prior to applying the tape, the method further comprises applying a conversion coating on the aluminum surface.

Embodiment 46 is the method of embodiment 45 wherein the conversion coating comprises a trivalent or hexavalent chrome.

Embodiment 47 is the method of any one of embodiments 42 through 46 wherein the step of exposing the masked substrate to an electrolyte solution comprises immersing the masked substrate in an electrolyte bath comprising chromic acid under conditions effective to form aluminum oxide;

Embodiment 48 is the method of any one of embodiments 42 through 47 wherein the pressure sensitive adhesive layer has a thickness of at least 10 micrometers.

Embodiment 49 is the method of any one of embodiments 42 through 48 wherein the pressure sensitive adhesive layer has a thickness of up to 36 micrometers.

Embodiment 50 is the method of any one of embodiments 42 through 49 wherein, when disposed on an aluminum substrate, the tape displays a peel adhesion strength of less than 30 oz/in (328 N/m) according to the Peel Adhesion Strength Test.

Embodiment 50.1 is the method of any one of embodiments 42 through 49 wherein, when disposed on an aluminum substrate, the tape displays a peel adhesion strength of less than 10 oz/in (110 N/m) according to the Peel Adhesion Strength Test.

Embodiment 51 is the method of any one of embodiments 42 through 50 wherein, when disposed on an aluminum substrate, the tape displays a leakage distance of less than 635 micrometers according to the Chromic Acid Anodization—Leakage Distance Test.

Embodiment 52 is the method of any one of embodiments 42 through 51 wherein, when disposed on an aluminum substrate, the tape displays a peel adhesion strength of at least 2 oz/in (21.9 N/m) according to the Peel Adhesion Strength Test.

Embodiment 53 is the method of any one of embodiments 42 through 52 wherein the backing has a thickness of greater than 65 micrometers, or greater than 66 micrometers, or greater than 67 micrometer, or greater than 68 micrometers, or greater than 69 micrometers, or at least 70 micrometers, at least 75 micrometers.

Embodiment 54 is the method of any one of embodiments 42 through 53 wherein the backing has a thickness of up to 190 micrometers, up to 180 micrometers, up to 170 micrometers, up to 160 micrometers, up to 150 micrometers, up to 140 micrometers, up to 130 micrometers, or up to 125 micrometers.

Embodiment 55 is the method of any one of embodiments 42 through 54 wherein the backing comprises a material selected from polyesters (such as polyethylene terephthalate and polyethylene naphthalate), polystyrene, polyolefin (such as polyethylene, polypropylene, including, e.g., monoaxially oriented polypropylene and biaxially oriented polypropylene), polytetrafluoroethylene, polyvinylfluoroethylene, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated).

Embodiment 56 is the method of embodiment 55 wherein the backing comprises polyethylene terephthalate.

Embodiment 57 is the method of any one of embodiments 42 through 56 wherein the backing comprises one or more additives selected from a filler (such as silicon dioxide), a catalyst (such as antimony trioxide), a plasticizer, a pigment, and a combination thereof.

Embodiment 58 is the method of any one of embodiments 42 through 57 wherein the rubber-based pressure sensitive adhesive comprises a silicone pressure sensitive adhesive.

Embodiment 59 is the method of embodiment 58 wherein the silicone pressure sensitive adhesive comprises a silicone gum and an M-Q resin.

Embodiment 60 is the method of embodiment 59 wherein the silicone gum comprises a polydiorganosiloxane.

Embodiment 61 is the method of embodiment 60 wherein the polydiorganosiloxane comprises a polydimethylsiloxane gum.

Embodiment 62 is the method of embodiment 60 or 61 wherein the polydiorganosiloxane is crosslinked with a monofunctional peroxide.

Embodiment 63 is the method of embodiment 62 wherein the monofunctional peroxide comprises dichlorobenzoyl peroxide, benzoyl peroxide, or a combination thereof.

Embodiment 64 is the method of any one of embodiments 58 through 63 wherein the silicone pressure sensitive adhesive comprises a silicone oil.

Embodiment 65 is the method of embodiment 64 wherein the silicone oil has a viscosity of less than 1000 centistokes, or less than 100 centistokes, or less than 50 centistokes.

Embodiment 66 is the method of embodiment 64 or 65 wherein the silicone oil comprises a polydiorganosiloxane fluid.

Embodiment 67 is the method of any one of embodiments 64 through 66 wherein the rubber-based pressure sensitive adhesive comprises greater than 3 wt-%, or at least 5 wt-%, or at least 8 wt-%, silicone oil, based on the total weight of the pressure sensitive adhesive.

Embodiment 68 is the method of any one of embodiments 64 through 67 wherein the rubber-based pressure sensitive adhesive comprises up to 25 wt-% silicone oil.

Embodiment 69 is the method of any one of embodiments 42 through 57 wherein the rubber-based pressure sensitive adhesive comprises a natural rubber pressure sensitive adhesive.

Embodiment 70 is the method of embodiment 69 wherein the natural rubber pressure sensitive adhesive comprises polyisoprene and a tackifying resin.

Embodiment 70a is the method of embodiments 42 through 57 wherein the rubber-based pressure sensitive adhesive comprises a polyisobutylene rubber pressure sensitive adhesive.

Embodiment 70b is the method of embodiment 70a wherein the polyisobutylene pressure sensitive adhesive rubber comprises a tackifying resin.

Embodiment 71 is the method of any one of embodiments 42 through 57 wherein the rubber-based pressure sensitive adhesive comprises a synthetic rubber pressure sensitive adhesive (other than a silicone pressure sensitive adhesive).

Embodiment 72 is the method of embodiment 71 wherein the synthetic rubber-based pressure sensitive adhesive comprises a styrene-containing block copolymer.

Embodiment 73 is the method of embodiment 72 wherein the styrene-containing block copolymer comprises a styrene-isoprene-styrene block copolymer, a styrene-butadiene-styrene block copolymer, a styrene-ethylene-butylene-styrene block copolymer, or a combination thereof.

Embodiment 74 is the method of any one of embodiments 42 through 73 wherein the rubber-based pressure sensitive adhesive comprises one or more additives selected from a tackifier (such as an M-Q resin, phenolic resin, or hydrocarbon polyterpene resin), an antioxidant (such as polyphenol polymer), a pigment, a stabilizer (such as 2,5-di-tert-amyl-hydroquinone), a filler (such as zinc oxide), an oil (such as mineral oil), a plasticizer (such as a silicone oil), a wax (such as lanolin), a lubricant, a process aid, and a combination thereof.

Embodiment 75 is the method of any one of embodiments 42 through 74 wherein the primed surface of the backing comprises a treated surface or a chemical coating layer, or both.

Embodiment 76 is the method of embodiment 75 wherein the primed surface comprises a treated surface.

Embodiment 77 is the method of embodiment 76 wherein the treated surface comprises a corona-treated surface, a plasma-treated surface, flame-treated surface, or an etched surface (e.g., sodium etched).

Embodiment 78 is the method of any one of embodiments 75 through 77 wherein the primed surface comprises a chemical coating layer.

Embodiment 79 is the method of embodiment 78 wherein the chemical coating layer comprises a phenolic, a polyterpene, a calcium zinc resinate, a polychloroprene, a polydiorganosiloxane, a copolymer of butadiene and acrylonitrile, or a combination thereof.

Embodiment 80 is the method of embodiment 79 wherein the chemical coating layer comprises a polychloroprene and/or a polydiorganosiloxane.

Embodiment 81 is the method of embodiment 80 wherein the chemical coating layer comprises a polydiorganosiloxane gum, an M-Q resin, a crosslinker, and a catalyst.

Note: embodiments herein referring to other embodiments having sub-embodiments (those enumerated with a decimal, for example 1.1 is a sub-embodiment of 1) should be read to include the sub-embodiments also, individually. For example, given embodiment 1 having sub-embodiments 1.1 and 1.2, a further embodiment 2 that refers to embodiment 1 should be read to include the combinations of the limitation of embodiment 2 and 1, as well as 2 and 1.1 and 2 and 1.2.

### Examples

The following examples are given to illustrate, but not limit, the scope of this disclosure. As used herein, all parts and percentages are by weight unless otherwise specified. All commercial materials were used as obtained from the vendor. Unless otherwise specified, materials can be obtained from SigmaAldrich Corp. (St. Louis, Mo.).

| MATERIALS | |
|---|---|
| Designation | Description |
| Silicone PSA 1 | A dispersion of polydimethylsiloxane gum and resin diluted with |
| | xylene to 55-58 wt % silicone solids, available under the trade |
| | designation DOW CORNING Q2-7406 ADHESIVE from Dow |
| | Corning, Auburn, MI. |
| Silicone PSA 2 | A toluene solution of polydimethylsiloxane gum and resin supplied at |
| | 60 wt % silicone solids in toluene, available under the trade |
| | designation SILGRIP PSA 590LD LOW DUSTING SILICONE |
| | PRESSURE SENSITIVE ADHESIVE from Momentive Performance |
| | Materials Incorporated, Waterford, NY. |
| DCBP Crosslinker | A 50 wt % paste of a monofunctional peroxide, dichlorobenzoyl |
| | peroxide, in silicone oil, available under the trade designation |
| | PERKADOX PD-50S-PS, from AkzoNobel N.V.. Amsterdam, |
| | Netherlands. |
| Silicone Oil Additive | A dimethylpolysiloxane silicone fluid having a viscosity of 50 |
| | centiStokes, available under the trade designation PST-850 50 cST |
| | SILICONE FLUID from PolySi Technologies, Sanford, NC. |
| Blue Pigment 1 | A dispersion of cobalt zinc aluminum blue spinel in silicone fluid, |
| | having a poly(dimethylsiloxane) content of about 25 wt % and a filler |
| | content of about 75 wt %, available under the trade designation |
| | FLOWSPERE SIC-3115, from Flow Polymers, LLC, Cleveland, |
| | OH. |
| Green Pigment | A dispersion of chrome (III) oxide green, CI Pigment Green in |
| | silicone fluid, having a poly(dimethylsiloxane) content of between 26 |
| | and 29 wt % and a filler content of about 70 wt %, available under the |
| | trade designation FLOWSPERSE SIC-3084 from Flow Polymers, |
| | LLC, Cleveland, OH. |
| Polyester Backing 20 | An untreated polyester film having a thickness of 0.002 inch (51 |
| | micrometers), available under the trade designation MYLAR M461, |
| | from DuPont Teijin Films, Chester, VA. |
| Polyester Backing 25 | An untreated polyester film having a thickness of 0.0025 inch (63.5 |
| | micrometers), available under the trade designation MYLAR M461, |
| | from DuPont Teijin Films, Chester, VA. |
| Polyester Backing 30 | A slightly rough-surfaced and hazy polyester film having a thickness |
| | of 0.003 inch (76 micrometers), available under the trade designation |
| | SKYROL SG00L 300ga POLYESTER FILM, from SKC Films, |
| | Covington, GA. |
| Polyester Backing 75 | A slightly rough-surfaced and hazy polyester film having a thickness |
| | of 0.0075 inch (191 micrometers), available under the trade |
| | designation SKYROL SG00L 750ga, from SKC Films, Covington, |
| | GA. |
| Primer Resin | A silicone gum solution, 29 wt % solids in xylene, suitable for use in |
| | formulating a primer composition, available under the trade |
| | designation SILFORCE SS4191A from Momentive Performance |
| | Materials Incorporated, Waterford, NY. |
| Primer Crosslinker | A methyl hydrogen crosslinker, suitable for use in formulating a |
| | primer composition, available under the trade designation SILFORCE |
| | SS4191B from Momentive Performance Materials Incorporated. |
| | Waterford, NY. |
| Primer Accelerator | A 50 wt % solids solution of poly(methylaminoalkoxy)siloxane |
| | polymer in toluene for use as a cure accelerator in the SILFORCE |
| | SS4191 release coating system, available under the trade designation |
| | SILFORCE SS4259C from Momentive Performance Materials |
| | Incorporated, Waterford, NY. |
| Primer Catalyst | Dibutyl tin diacetate catalyst, 43 wt % solids in toluene, available |
| | under the trade designation SILFORCE SS4192C from Momentive |
| | Performance Materials Incorporated, Waterford, NY. |
| Resin 1 | A phenolic resin having a softening point of 180 to 210° F. (82 to |
| | 99° C.), available under trade designation PHENOLIC RESIN BKR- |
| | 2620, from Georgia-Pacific LLC, Atlanta, GA. |
| Resin 2 | A low molecular weight, thermoplastic hydrocarbon polyterpene |
| | resin having a softening point of 130 to 136° C.,, available under trade |
| | designation PICCOLYTE S135, from Pinova incorporated, |
| | Brunswick, GA. |
| Resin 3 | A calcium zinc resinate of disproportionated rosin having a softening |
| | point of 148° C., available under trade designation PINEREZ 9089 |
| | from Lawter, Incorporated, Chicago IL. |
| Resin 4 | An oil soluble, heat-reactive, phenolic resin based on para-substituted |
| | alkylphenol having a softening point of 92 to 100° C., available under |
| | trade designation HRJ-1367, from SI Group Incorporated, |
| | Schenectady, NY. |
| Rubber 1 | A natural rubber, available under trade designation SIR-3L |
| | NATURAL RUBBER, from RCMA AMERICAS, Incorporated, |
| | Uniontown, OH. |
| Rubber 2 | A natural rubber, available under trade designation SIR CV60 PALE |
| | CREPE NATURAL RUBBER, from RCMA AMERICAS, |
| | Incorporated, Uniontown, OH. |
| Rubber 3 | A copolymer of butadiene and acrylonitrile, available under trade |
| | designation NIPOL 1002, from Zeon Chemicals L.P., Bells Lane, |
| | KY. |
| Rubber 4 | A non-staining general purpose polychloroprene rubber having a |
| | Mooney viscosity (ML 1 + 4 at 100° C.) of 40-49, available under trade |
| | designation NEOPRENE W, from DuPont, Wilmington, DE. |
| Tackifier 1 | A rosin material, available under the trade designation PINEREZ |
| | 1277 (NC), from Lawter, Incorporated, Chicago IL. |
| Tackifier 2 | A low molecular weight, thermoplastic hydrocarbon polyterpene |
| | resin having a softening point of 112 to 118° C., available under the |
| | trade designation, PICCOLYTE S-115 from Pinova, Incorporated, |
| | Brunswick, GA. |
| Filler 1 | Zinc oxide powder, available under the trade designation ZINC |
| | OXIDE MAXIMO 318, from ZINC NACIONAL, S.A., |
| | MONTERREY, MEXICO. |
| Antioxidant 1 | A polyphenol type antioxidant powder, available under trade |
| | designation WINGSTAY L, from OMNOVA Solutions Incorporated, |
| | Beachwood, OH. |
| Stabilizer 1 | A sterically hindered dihydroxybenzene-based compound, 2,5-di-tert- |
| | amyl-hydroquinone, available under trade designation LOWINOX |
| | AH25 STABLIZER, from Addivant LLC, Danbury, CT. |
| Additive 1 | Lanolin, a complex, waxy substance containing varying amounts of |
| | long-chain waxy esters and lanolin alcohols, acids, and polycarbons, |
| | available under the trade designation LANOLIN USP |
| | (PHARMACEUTICAL LIGHT GRADE) from RITA Corporation, |
| | Crystal Lake, IL. |
| Blue Pigment 2 | A tinctorally strong red shade blue pigment, available under trade |
| | designation GRAPHTOL BLUE AN 01, from Clariant Incorporated, |
| | Charlotte, NC. |
| Yellow Pigment | A yellow colored powder, available under trade designation |
| | SUNBRITE YELLOW 14, from Sun Chemical Corporation, |
| | Cincinnati, OH. |
| Rubber 5 | Kraton D 1340 KT, a dissimilar arm, styrene-isoprene star polymer |
| | with 9.2% styrene content, made according to U.S. Pat. No. |
| | 5,393,787, the subject matter of which is hereby incorporated herein |
| | in its entirety, obtained from Kraton Performance Polymers, |
| | Incorporated, Houston, TX. |
| Tackifier 3 | An aliphatic hydrocarbon resin, available under trade designation |
| | ESCOREZ 1304 from Exxon Mobile Corporation, Irving, TX. |
| Resin 5 | A heat reactive resin, made from octylphenol and formaldehyde, |
| | available under trade designation HRJ-1367 from SI Group |
| | Incorporated, Schenectady, NY. |
| Mineral Oil | A mineral oil or paraffin oil which is a mixtures of higher alkanes |
| | from a mineral source, available under trade designation 831AA |
| | MINERAL OIL, from Vi-Jon Incorporated. St Louis, MO. |
| Stabilizer 2 | A dialkyl ester of thiodipropionic acid, available under trade |
| | designation IRGANOX 800, from BASF Corporation, Charlotte, |
| | NC. |
| Rubber 6 | A polyisobutylene rubber available under trade designation |
| | EFROLEN P85, from ChemSpec, Limited, Uniontown, OH. |
| Rubber 7 | A polyisobutene (polyisobutylene) rubber having a number average |
| | molecular weight of 75,000 grams/mole, a polydispersity index of |
| | 3.4, and a glass transition temperature (Tg) of −64° C., available under |
| | trade designation OPPANOL B 15 SFN, from BASF Corporation, |
| | Florham Park, NJ. |
| Tackifier 4 | A water white, cycloaliphatic hydrocarbon resin, having a glass |
| | transition temperature of 187° C., a number average molecular weight |
| | of 400 grams/mole, and a weight average molecular weight of 730 |
| | grams/mole, available under trade designation ESCOREZ 5340 |
| | from Exxon Mobile Corporation, Irving, TX. |
| Argon PC 400 | A dark green polyester tape having a 0.002 inch (51 micrometers) |
| | thick polyester backing and a 0.0015 inch (38 micrometers) thick |
| | silicone adhesive, available under trade designation PC 400 GREEN |
| | POWDER COATING TAPE, from ARGON Masking Incorporated |
| | Monrovia, CA. |
| 3M 8901 | A blue polyester tape with silicone adhesive having a backing |
| | thickness of 0.0009 inch (23 micrometers) and a total thickness of |
| | 0.0024 inch (61 micrometers), available under trade designation |
| | POLYESTER TAPE 8901, from 3M Company, St. Paul, MN. |
| 3M 8902 | A blue polyester tape with silicone adhesive having a backing |
| | thickness of 0.002 inch (51 micrometers) and a total thickness of |
| | 0.0035 inch (89 micrometers), available under trade designation |
| | POLYESTER TAPE 8901, from 3M Company, St. Paul, MN. |
| 3M 8905 | A blue polyester tape with silicone adhesive having a backing |
| | thickness of 0.005 inch (127 micrometers) and a total thickness of |
| | 0.0065 inch (165 micrometers), available under trade designation |
| | POLYESTER TAPE 8905, from 3M Company, St. Paul, MN. |
| 3M 8992 | A dark green colored polyester tape with silicone adhesive having a |
| | backing thickness of 0.002 inch (51 micrometers) and a total |
| | thickness of 0.0032 inch (81 micrometers), available under trade |
| | designation POLYESTER TAPE 8992, from 3M Company, St. Paul, |
| | MN. |
| 2024 | A Type 2024 aluminum panel, identified under the item number |
| | 88835K14, obtained from McMaster Carr, Chicago, IL. |

Three commonly used aluminum alloy series are 2000, 6000, and 7000. Specifically tested alloys were aluminum alloys 2024, 6061, and 7075. The most difficult to mask with minimal leakage distance was 2024 followed by 7075, then 6061. Thus, the following tests were done on aluminum alloy 2024.

### Test Methods

### Chromic Acid Anodization (CAA)—Leakage Distance—Method A

Unpolished aluminum panels of the 2024 type, measuring 4 inches by 6 inches by 0.05 inch (10.2 centimeters by 15.2 centimeters by 1.27 millimeters), having a surface roughness average, Ra, value of between 0.382 and 0.463 micrometer (as measured using MARSURFM-300 PROFILOMETER with probe RD 18C, from Mahr Federal Incorporated, Providence, R.I.) were employed. The panels were cleaned using an Alkaline-Deox treatment as follows. First the panels were immersed in a solution of D-909 HEAVY DUTY MULTIPURPOSE METAL CLEANER (available from Chemtech Finishing Systems, Incorporated, Farmington Hills, Mich.) at 150° F.+/−15° F. (66° C.+/−8.3° C.) for 5-7 minutes, at a concentration of 3-6 ounces/gallon (22-45 grams/liter). Next, the panels were treated for acid etching, with a mixture solution of about 30 volume-% Nitric Acid and 2 volume-% Hydrofluoric Acid, for no more than 30 seconds, at about 75-85° F. (24-29° C.). Next, after rinsing with water at about 72° F. (22° C.), the panels were then immersed in a solution of CHEMETALL DEOXIDIZER LNC (12-20 volume-% concentration; available from Oakite Products, Incorporated, Berkeley Heights, N.J.) at 72° F. (22° C.) for no more than 5 minutes. The panels were again rinsed with water, then dried using compressed air.

Within about 6 hours four tape strips of a tape construction, cut with a razor blade and measuring 1 inch wide by 4 inches long (2.5 by 10.2 centimeters), were applied to one side of a cleaned aluminum panel by hand, followed by rolling down the samples with a rubber roller one time in one direction, then running a plastic scraper blade down along the length of the tape strip several times to ensure intimate contact with the panel, especially along edges. Another four tape strips of a different construction were then applied in the same manner to the opposite side of the aluminum panel. The taped panel was allowed to dwell for between 8 and 24 hours at 72° F. (22° C.) before anodization. Next the taped panel was anodized for 60 minutes at 100° F.+/−10° F. (38° C.+/−5.6° C.) and 40 Volts in a Chromic Acid bath having a chromic acid concentration of 42 to 90 grams/liter and a pH between 0.5 and 0.9. After removal from the acid bath, the panel was placed in two separate water baths, both set at 72° F. (22° C.) and rinsed for between 1 and 3 minutes per bath. The anodized, taped panel was placed in a hot water seal tank at approximately 200° F. (93° C.) for between 15 and 60 minutes, then dried using compressed air.

The resulting anodized taped panels were evaluated at 20× magnification for the leakage distance of chromic acid under both lengthwise edges of each tape strip at 0.5 inch (12.7 millimeters) intervals for a total of 14 data points/tape strip, and a total of 56 data points/4 test strips. The first and last data points were taken at 0.5 inch (12.7 millimeters) from the end of each strip. The leakage area was visible due to anodization having taken place under the tape where the acid leaked. The average of the 56 data points was reported. In some cases the leaking distance was excessive. In those cases, the lowest leakage distance value was reported. In some cases, the tape strip fell of the substrate in the chromic acid bath. In those instances the result was recorded as “Pop-off”.

### Chromic Acid Anodization (CAA)—Leakage Distance—Method B

Unpolished aluminum panels of the 2024 type, measuring 4 inches by 6 inches by 0.05 inches (10.2 centimeters by 15.2 centimeters by 1.27 millimeters), having a surface roughness average, Ra, value of between 0.382 and 0.463 micrometers (as measured using MARSURFM-300 PROFILOMETER with probe RD 18C, from Mahr Federal Incorporated, Providence, R.I.) were employed. The panels were cleaned using an Alkaline-Deox treatment as follows. First the panels were immersed in a solution of OAKITE 166, alkaline aluminum cleaner (available from Oakite Products, Incorporated, Berkeley Heights, N.J.) at 150° F.+/−15° F. (66° C.+/−8.3° C.) for 5-7 minutes, at a concentration of 6-7 ounces/gallon (45-53 grams/liter). Next, after rinsing with water at about 72° F. (22° C.), the panel was then immersed in a solution of CHEMETALL DEOXIDIZER LNC (15-20 volume-% concentration; available from Oakite Products, Incorporated, Berkeley Heights, N.J.) at 72° F. (22° C.) for no more than 5 minutes. The panels were again rinsed with water, then dried using compressed air.

Within about 2 hours four tape strips of a tape construction, cut with a razor blade and measuring 1 inch wide by 4 inches long (2.5 by 10.2 centimeters), were applied to one side of a cleaned aluminum panel by hand, followed by rolling down the samples with a rubber roller one time in one direction, then running a plastic scraper blade down along the length of the tape strip several times to ensure intimate contact with the panel, especially along edges. Another four tape strips of a different construction were then applied in the same manner to the opposite side of the aluminum panel. The taped panel was allowed dwell for between 2 and 3 hours at about 72° F. (22° C.) before anodization. Next the taped panel was anodized for about 50 minutes at 95° F.+/−5° F. (35° C.+/−2.8° C.) and 40 Volts in a Chromic Acid bath having a chromic acid concentration of between 40-52 grams/liter and a pH between 0.5 and 0.9. After removal from the acid bath the panel was rinsed with the water at about 72° F. (22° C.) for between 1 and 2 minutes. The anodized, taped panel was placed in a hot water seal tank at approximately 200° F. (93° C.) for between 5-10 minutes, then dried using compressed air.

The resulting anodized taped panel was evaluated at 20× magnification for the leaking distance of chromic acid under both lengthwise edges of each tape strip at 0.5 inch (12.7 millimeters) intervals for a total of 14 data points/tape strip, and a total of 56 data points/4 test strips. The first and last data points were taken at 0.5 inch (12.7 millimeters) from the end of each strip. The leakage area was visible due to anodization having taken place under the tape where the acid leaked. The average of the 56 data points was reported. In some cases the leaking distance was excessive. In those cases, the lowest leaking distance value was reported. In some cases, the tape strip fell of the substrate in the chromic acid bath. In those instances the result was recorded as “Pop-off”.

### Peel Adhesion Strength

Peel adhesion strength was measured according to ASTM D-3330/D3330M—04 (2010): “Peel Adhesion of Pressure-Sensitive Tape”—Test Method A, with the following modifications. A 1.0-inch (25.4 millimeters) wide tape strip was applied to Type 2024 Aluminum Panels cleaned as described in the test method “Chromic Acid Anodization (CAA)—Leakage Distance” above. A 4.5-pound (2.04 kilogram) hard rubber roller was passed twice in each direction over the tape strip to ensure intimate contact. After a dwell time of between 3 and 5 minutes, the peel adhesion strength was measured at a peel rate of 12 inches/minute (30 centimeters/minute). Three test strips were evaluated and the average value reported. The dwell and test conditions were 22° C. and about 50% Relative Humidity.

### Backing Flexibility

The flexibility of materials used as backings can be calculated using the following equation.

D=Et³/12(1−v²)

Where D is the backing flexibility, E is the tensile or Young's Modulus of the backing, t is the backing thickness, and v is Poissons ratio of the backing material. It is desirable to have flexibility values of less than 0.00324 N-m, or 0.00096 N-m, or 0.0002075 N-m, or 0.00012 N-m, or lower.

### Preparation of Pressure Sensitive Adhesive Precursors

### Method A—Silicone

The materials shown in Table 1A were mixed in a container using a mechanical mixer for about 15 minutes to provide Adhesive Precursors 1, 2, 3, 5, and 6. The Adhesive Precursors 1, 2, 3, 5, and 6 were then used to prepare pressure sensitive tapes as described below.

TABLE 1A
Silicone Adhesive Precursor Composition -

| | Adhesive | Adhesive | Adhesive | Adhesive | Adhesive |
|---|---|---|---|---|---|
| | Precursor 1 | Precursor 2 | Precursor 3 | Precursor 5 | Precursor 6 |
| Material | Parts by Weight (pbw) | | | | |
| *Silicone PSA 1 | 61.67 | 57.56 | 54.53 | 0.00 | 0.00 |
| *Silicone PSA 2 | 0 | 0 | 0 | 79.77 | 71.79 |
| Toluene | 34.86 | 37.25 | 38.55 | 16.54 | 19.73 |
| Green Pigment | 2.78 | 2.78 | 2.78 | 0.00 | 0.00 |
| Blue Pigment 1 | 0 | 0 | 0 | 2.19 | 2.19 |
| DCBP | 0.69 | 0.69 | 0.69 | 1.50 | 1.50 |
| Crosslinker | | | | | |
| Silicone Oil | 0.00 | 1.72 | 3.45 | 0.00 | 4.79 |
| Additive | | | | | |
| % Silicone Oil | 0.00 | 5.02 | 10.07 | 0.00 | 9.4 |
| Additive | | | | | |
| **% Total | 3.0 | 8.0 | 13.0 | 2.5 | 11.8 |
| Silicone Oil | | | | | |
| Total | 100.00 | 100.00 | 100.00 | 100.00 | 100.00 |
| % Solids | 38 | 38 | 38 | 51 | 51 |

*Silicone PSA amounts are of the PSA dispersion.
**Total Silicone Oil includes oil from crosslinker paste, pigment paste, and silicone oil additive.

### Method B—Silicone

The materials shown in Table 1B were mixed in a container using a mechanical mixer for about 10 minutes to provide Adhesive Precursors 1, 3, and 4. The Adhesive Precursors 1, 3, and 4 were then used to prepare pressure sensitive tapes as described below.

TABLE 1B
Silicone Adhesive Precursor Compositions

| | Adhesive | Adhesive | Adhesive |
|---|---|---|---|
| | Precursor 1 | Precursor 3 | Precursor 4 |
| Material | Parts by Weight (pbw) | | |
| *Silicone PSA 1 | 61.67 | 54.53 | 48.47 |
| Toluene | 34.86 | 38.55 | 41.16 |
| Green Pigment | 2.78 | 2.78 | 2.78 |
| DCBP Crosslinker | 0.69 | 0.69 | 0.69 |
| Silicone Oil Additive | 0.00 | 3.45 | 6.90 |
| % Silicone Oil Additive | 0.00 | 10.07 | 20.10 |
| **% Total Silicone Oil | 3.0 | 13.0 | 22.9 |
| Total | 100.00 | 100.00 | 100.00 |
| % Solids | 38 | 38 | 38 |

*Silicone PSA amounts are of the PSA dispersion.
**Total Silicone Oil includes oil from crosslinker paste, pigment paste, and silicone oil additive.

### Preparation of Primed Films

### Method A

Primer precursor composition 1 was prepared using the materials shown in Table 2 using the same process as described for “Preparation of Silicone Pressure Sensitive Adhesive Precursors—Method A”. The primer precursor composition was applied by gravure roll to a moving web of the starting films shown in Table 3 and dried and cured for about 7 to 8 seconds at 375° F. (191° C.) to give a dried coating weight of about 1.92 grams/square meter.

TABLE 2
Primer Precursor Composition 1

| | Amount |
|---|---|
| Material | (pbw) |
| Primer Resin | 14.69 |
| Primer Crosslinker | 0.32 |
| Primer Accelerator | 0.32 |
| Primer Catalyst | 0.16 |
| Methyl Ethyl Ketone | 15.61 |
| Heptane | 68.88 |
| Total | 100 |
| % Total Solids | 5 |

### Method B

The “Preparation of Primed Films—Method A” was repeated with the following modifications. The primer precursor composition 1 was coated onto the film using a #6 Meyer rod and placed in a forced air oven for about 5 minutes at 300° F. (149° C.) to dry and cure the primer precursor composition. A dried coating weight of about 1.92 grams/square meter was obtained.

### Preparation of Pressure Sensitive Adhesive Tapes

### Method A—Silicone

Adhesive Precursor compositions 1, 2, 3, 5, and 6 made using “Preparation of Silicone Pressure Sensitive Adhesive Precursors—Method A” were coated over the primed surface of the film prepared in “Preparation of Primed Films—Method A” using a three roll coater, and dried and cured in a forced air oven at 275° F. (135° C.) for about 23 seconds and at 325° F. (163° C.) for about 45 seconds. The adhesive thicknesses were varied as shown in Table 3. Cured protective tapes having various silicone pressure sensitive adhesives thereon were thus obtained. A summary of adhesive type/thickness and backing type/thickness is shown in Table 3.

### Method B—Silicone

The “Preparation of Silicone Pressure Sensitive Adhesive Tapes—Method A” was repeated with the following modifications. Adhesive Precursor compositions 1, 3, and 4 made using “Preparation of Silicone Pressure Sensitive Adhesive Precursors—Method B” were coated over the primed surface of the film prepared in “Preparation of Primed Films—Method B” using a notch bar coater, and dried and cured in a forced air oven at 300° F. (149° C.) for about 5 minutes. The adhesive thicknesses were varied as shown in Table 3. Cured protective tapes having various silicone pressure sensitive adhesives thereon were thus obtained. A summary of adhesive type/thickness and backing type/thickness is shown in Table 3.

TABLE 3
Protective Tape Constructions and Results

| | | | | | | | | | Peel |
|---|---|---|---|---|---|---|---|---|---|
| | | Adhesive Precursor/ | | | Adhesive | Backing | | Leakage | Adhesion |
| | Precursor | Primer/Tape Preparation | Adhesive | Polyester | Thickness | Thickness | Total Si | Distance | Strength |
| Ex. | (1-7) | Method | Type | Backing | (micrometers) | (micrometers) | Oil (wt %) | (inches) | (oz/inch) |
| 1 | 2 | A/A/A | Silicone | 30 | 12.5 | 76.2 | 8.0 | 0.030 | 8.77 |
| 2 | 3 | A/A/A | Silicone | 30 | 12.5 | 76.2 | 13.0 | 0.027 | 8.21 |
| 3 | 4 | B/B/B | Silicone | 30 | 12.5 | 76.2 | 22.9 | 0.022 | 5.46 |
| 4 | 3 | B/B/B | Silicone | 75 | 12.5 | 177.8 | 13.0 | 0.017 | 2.27 |
| C1 | 1 | A/A/A | Silicone | 30 | 12.5 | 76.2 | 3.0 | 0.038 | 10.50 |
| C2 | 1 | A/A/A | Silicone | 20 | 12.5 | 50.8 | 3.0 | Pop-off | 16.01 |
| C3 | 3 | A/A/A | Silicone | 20 | 12.5 | 50.8 | 13.0 | Pop-off | 5.22 |
| C4 | 1 | B/B/B | Silicone | 25 | 12.5 | 64 | 3.0 | Pop-off | ND |
| C5 | 3 | B/B/B | Silicone | 25 | 12.5 | 64 | 13.0 | 0.045** | ND |
| C6 | 5 | A/A/A | Silicone | 30 | 17.9 | 76.2 | 2.5 | 0.060 | ND |
| C7 | 6 | A/A/A | Silicone | 30 | 17.9 | 76.2 | 11.8 | 0.056 | ND |
| C8 | 1 | B/B/B | Silicone | 30 | 19 | 76 | 3.0 | 0.052 | 18.09 |
| C9 | 3 | B/B/B | Silicone | 30 | 19 | 76 | 13.0 | 0.051 | 7.34 |
| C10 | 1 | A/A/A | Silicone | 20 | 25.4 | 50.4 | 3.0 | Pop-off | ND |
| C11 | 3 | A/A/A | Silicone | 20 | 25.4 | 50.4 | 13.0 | Pop-off | ND |
| C12 | 1 | A/A/A | Silicone | 30 | 25.4 | 76.2 | 3.0 | >0.160* | 29.17 |
| C13 | 3 | A/A/A | Silicone | 30 | 25.4 | 76.2 | 13.0 | >0.045* | 19.00 |
| C14 | NA | NA | Silicone | NA | 30.6 | 50.8 | Unknown | Pop-off | 45.09 |
| 3M 8992 | | | | | | | | | |
| C15 | NA | NA | Silicone | NA | 35.6 | 25.4 | 2.5 | Pop-off | ND |
| 3M 8901 | | | | | | | | | |
| C16 | NA | NA | Silicone | NA | 35.6 | 50.8 | 2.5 | Pop-off | ND |
| 3M 8902 | | | | | | | | | |
| C17 | NA | NA | Silicone | NA | 38.1 | 50.8 | Unknown | Pop-off | 49.42 |
| ARGON | | | | | | | | | |
| PC 400 | | | | | | | | | |
| C18 | 3 | A/A/A | Silicone | 30 | 50.8 | 76.2 | 13.0 | Pop-off | ND |
| C19 | NA | NA | Silicone | NA | 35.6 | 127 | 2.5 | 0.025 | 32.52 |
| 3M 8905 | | | | | | | | | |
| 5 | 7 | C/C/C | Rubber | 30 | 12.5 | 76.2 | NA | 0.027 | 2.12 |
| 6 | 7 | C/C/C | Rubber | 30 | 25.4 | 76.2 | NA | 0.029 | 19.31 |
| C20 | 7 | C/C/C | Rubber | 30 | 50.8 | 76.2 | NA | 0.035 | 29.12 |
| 7 | 8 | D/C/D | Synthetic Rubber | 30 | 12.7 | 76.2 | NA | .023 | 14.43 |
| 8 | 8 | D/C/D | Synthetic Rubber | 30 | 25.4 | 76.2 | NA | 0.028 | 14.69 |
| C21 | 8 | D/C/E | Synthetic Rubber | 30 | 25.4 | 76.2 | NA | *.04 | 18.61 |
| C22 | 8 | D/C/E | Synthetic Rubber | 30 | 12.7 | 76.2 | NA | 0.032 | 14.77 |
| 9 | 9 | E/—/F | Polyisobutylene | 30 | 12.7 | 76.2 | NA | 0.029 | 29.60 |
| C23 | 10 | E/—/F | Polyisobutylene | 30 | 15.24 | 76.2 | NA | 0.039 | 30.90 |
| 10 | 11 | E/—/F | Polyisobutylene | 30 | 15.24 | 76.2 | NA | 0.029 | 28.97 |
| 11 | 12 | E/—/F | Polyisobutylene | 30 | 17.6 | 76.2 | NA | 0.026 | 49.66 |
| 12 | 13 | E/—/F | Polyisobutylene | 30 | 15.24 | 76.2 | NA | 0.027 | 46.81 |

NA: not applicable
ND: not determined
*The leaking distance was excessive; the lowest leaking distance value is shown.
**One tape strip failed due to Pop-off. The reported value is based on three tape strips.

### Preparation of Pressure Sensitive Adhesive Precursor

### Method C—Natural Rubber

The materials shown in Table 4 were used to prepare a natural rubber adhesive precursor as follows. Rubber 2, Stabilizer 1, and Yellow Pigment were combined using a BANBURY internal batch mixer. This blend was then combined with a heptane solution of cyclohexylamine using a COWLES agitating mixer to provide Premix 1. Premix 2 containing the same composition except with Blue Pigment 2 was prepared in the same manner. Premix 3 was prepared with Rubber 1, Filler 1, and Antioxidant 1 using a BANBURY mixer. Premixes 1, 2, and 3 were combined with Tackifier 1, Tackifier 2, Additive 1, heptane, and alcohol using a churn mixer until the components were all dissolved and dispersed to provide a homogenous solution of Adhesive Precursor 7. The Adhesive Precursor 7 was then used to prepare pressure sensitive tapes as described below.

TABLE 4
Natural Rubber Adhesive Precursor Composition

| Material | Adhesive Precursor 7 (pbw) |
|---|---|
| Heptane | 76.25 |
| Alcohol | 0.79 |
| Tackifier 1 | 5.39 |
| Tackifier 2 | 1.79 |
| Rubber 1 | 12.58 |
| Filler 1 | 1.26 |
| Antioxidant 1 | 0.25 |
| Rubber 2 | 0.006 |
| Stabilizer 1 | 0.001 |
| Blue Pigment 2 | 0.001 |
| Yellow Pigment | 0.022 |
| Cyclohexylamine | 0.11* |
| Additive 1 | 1.66 |
| Total | 100.00 |
| % Solids | 23 |

*parts per million (ppm)

### Preparation of Pressure Sensitive Adhesive Precursor

### Method D—Synthetic Rubber

The materials shown in Table 5 were used to prepare a synthetic rubber adhesive precursor as follows. Rubber 5, Tackifier 3, Resin 5, Mineral Oil, Antioxidant 1, and Stabilizer 2 were weighed into a glass jar. Toluene was then added, the jar tightly sealed and placed on a two roll mixer for 5-6 hours to dissolve all the components and provide a homogenous solution of Adhesive Precursor 8. The Adhesive Precursor 8 was then used to prepare pressure sensitive tapes as described below.

TABLE 5
Synthetic Rubber Adhesive Precursor Composition

| Material | Adhesive Precursor 8 (pbw) |
|---|---|
| Toluene | 70 |
| Rubber 5 | 18.69 |
| Tackifier 3 | 7.48 |
| Resin 5 | 1.57 |
| Mineral Oil | 1.87 |
| Antioxidant 1 | 0.2 |
| Stabilizer 2 | 0.2 |
| Total | 100.00 |
| % Solids | 30 |

### Preparation of Pressure Sensitive Adhesive Precursors

### Method F—Polyisobutylene Rubber

The materials shown in Table 6 were used to prepare a polyisobutylene rubber adhesive precursor as follows. Rubber 6, Rubber 7 and Tackifier 4 and Heptane were weighed and added to a glass vials. Vials were sealed and the components were mixed at room temperature on a roller for approximately 12 hours.

TABLE 6
Polyisobutylene Rubber Adhesive Precursor Compositions

| | Adhesive | Adhesive | Adhesive | Adhesive | Adhesive |
|---|---|---|---|---|---|
| | Precursor 9 | Precursor 10 | Precursor 11 | Precursor 12 | Precursor 13 |
| Material | (pbw) | (pbw) | (pbw) | (pbw) | (pbw) |
| Heptane | 65 | 65 | 65 | 65 | 65 |
| Rubber 6 | 12.25 | 10.5 | 10.5 | 8.75 | 8.75 |
| Rubber 7 | 14 | 14 | 15.75 | 15.75 | 17.5 |
| Tackifier 4 | 8.75 | 10.5 | 8.75 | 10.5 | 8.75 |
| Total | 100.00 | 100.00 | 100.00 | 100.00 | 100.00 |
| % Solids | 35 | 35 | 35 | 35 | 35 |

### Preparation of Primed Films

### Method C

Primer precursor composition 2 was prepared using the materials shown in Table 7 as follows. Rubbers 3 and 4 were combined using a BANBURY internal batch mixer. The resulting blend was then combined with the other materials in a container using a paddle mixing blade to provide the primer precursor composition. The primer precursor composition 2 was coated onto the starting film shown in Table 3 using a #6 Meyer rod and placed in a forced air oven for about 5 minutes at 190° F. (88° C.) to dry and cure the primer precursor composition to give a dried coating weight of about 2.4 grams/square meter.

TABLE 7
Primer Precursor Composition 2

| Material | Amount (pbw) |
|---|---|
| Toluene | 47.8 |
| Methyl Ethyl Ketone | 25.36 |
| Isopropyl Alcohol | 4.6 |
| Resin 1 | 1.5 |
| Stabilizer 1 | 0.3 |
| Resin 2 | 3.8 |
| Resin 3 | 3.8 |
| Resin 4 | 5.3 |
| Rubber 3 | 5.7 |
| Rubber 4 | 1.9 |
| Total | 100.0 |
| % Solids | 22 |

### Preparation of Pressure Sensitive Adhesive Tapes

### Method C—Natural Rubber

Tapes were prepared using the Adhesive Precursor Composition 7 made as described above. The composition was coated over the primed surface of the film prepared in “Preparation of Primed Films—Method C” using a notch bar coater, and dried and cured in a forced air oven at 190° F. (88° C.) for about 5 minutes. The adhesive thicknesses were varied as shown in Table 3. Cured protective tapes having a natural rubber pressure sensitive adhesive thereon were thus obtained. A summary of adhesive type/thickness and backing type/thickness is shown in Table 3.

### Preparation of Pressure Sensitive Adhesive Tapes

### Method D—Synthetic Rubber

Tapes were prepared using the Adhesive Precursor Composition 8 made as described above. The composition was coated over the primed surface of the film prepared in “Preparation of Primed Films—Method C” using a notch bar coater, and dried and cured in a forced air oven at 150° F. (65° C.) for about 5 minutes. The adhesive thicknesses were varied as shown in Table 3. Cured protective tapes having a synthetic rubber pressure sensitive adhesive thereon were thus obtained. A summary of adhesive type/thickness and backing type/thickness is shown in Table 3.

### Method E—Synthetic Rubber

Tapes were prepared using the Adhesive Precursor Composition 8 made as described above. The composition was coated over the primed surface of the film prepared in “Preparation of Primed Films—Method C” using a notch bar coater, and dried and cured in a forced air oven at 300° F. (149° C.) for about 5 minutes. The adhesive thicknesses were varied as shown in Table 3. Cured protective tapes having a synthetic rubber pressure sensitive adhesive thereon were thus obtained. A summary of adhesive type/thickness and backing type/thickness is shown in Table 3.

### Preparation of Pressure Sensitive Adhesive Tapes

### Method F—Polyisobutylene Rubber

Tapes were prepared using the Adhesive Precursor Composition 9-13 made as described above. The compositions were coated over Polyester Backing 30 using a knife coater and the coated samples were dried and cured in an oven at 158° F. (70° C.) for about 15 minutes. The adhesive thicknesses were varied as shown in Table 3. Cured protective tapes having a polyisobutylene rubber pressure sensitive adhesive thereon were thus obtained. A summary of adhesive type/thickness and backing type/thickness is shown in Table 3.

### Backing Flexibility

The flexibility of the backing materials used was calculated as described in the “Backing Flexibility” test methods above. A Young's modulus value of 4.7 GigaPascals and an average Poissons ratio value of 0.405 were used. The results are shown in Table 8 below.

TABLE 8
Backing Flexibility

| Backing | Flexibility (Newton-meters) |
|---|---|
| Polyester Backing 20 | 0.0000614 |
| Polyester Backing 25 | 0.00012 |
| Polyester Backing 30 | 0.000207 |
| 3M 8905 Backing | 0.00096 |
| Polyester Backing 75 | 0.00324 |

The referenced descriptions contained in the patents, patent documents, and publications cited herein are incorporated by reference in their entirety as if each were individually incorporated. Various unforeseeable modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only, with the scope of the disclosure intended to be limited only by the claims set forth herein as follows.

1. A masking tape comprising:
a flexible backing layer having two major surfaces, wherein the backing layer has a thickness of greater than 64 micrometers and up to 200 micrometers, and one major surface of the backing layer comprise a primed surface; and
a rubber-based pressure sensitive adhesive layer disposed on the primed surface of the backing layer, wherein the pressure sensitive adhesive layer has a thickness of 7.6 micrometers to 25 micrometers;
wherein, when disposed on an aluminum substrate, the masking tape displays a peel adhesion strength of less than 50 oz/in (547 N/m) according to a Peel Adhesion Strength Test, and a leakage distance of less than 762 micrometers according to a Chromic Acid Anodization Leakage Distance Test.

2. The masking tape of claim 1 wherein, when disposed on an aluminum substrate, the masking tape displays a peel adhesion strength of less than 30 oz/in (328 N/m).

3. The masking tape of claim 1 wherein, when disposed on an aluminum substrate, the masking tape displays a peel adhesion strength of less than 20 oz/in (219 N/m).

4. The masking tape of claim 1 wherein, when disposed on an aluminum substrate, the masking tape displays a peel adhesion strength of less than 10 oz/in (110 N/m) according to the Peel Adhesion Strength Test.

5. The masking tape of claim 1 wherein, when disposed on an aluminum substrate, the masking tape displays a leakage distance of less than 635 micrometers according to the Chromic Acid Anodization—Leakage Distance Test.

6. The masking tape of claim 1 wherein the backing has a thickness of at least 75 micrometers.

7. The masking tape of claim 1 wherein the pressure sensitive adhesive layer has a thickness of at least 10 micrometers.

8. The masking tape of claim 1 wherein the pressure sensitive adhesive layer has a thickness of up to 15 micrometers.

9. The masking tape of claim 1 wherein the backing comprises a material selected from polyesters (such as polyethylene terephthalate and polyethylene naphthalate), polystyrene, polyolefins (such as polyethylene, polypropylene, including, e.g., monoaxially oriented polypropylene and biaxially oriented polypropylene), polytetrafluoroethylene, polyvinylfluoroethylene, polyurethane, polyimide, polyamide, polyetheretherketone, liquid-crystal polyarylate, polyether sulfide, metal foils (such as aluminum, lead, and stainless steel), polyphenylene sulfide, polycarbonate, polyvinyl chloride, and combinations thereof (e.g., mixtures, copolymers, as well as composite supports having a plurality of layers of the foregoing materials laminated).

10. The masking tape of claim 1 wherein the rubber-based pressure sensitive adhesive comprises a silicone pressure sensitive adhesive.

11. The masking tape of claim 10 wherein the silicone pressure sensitive adhesive comprises a silicone gum and an M-Q resin.

12. The masking tape of claim 11 wherein the silicone gum comprises a polydiorganosiloxane.

13. The masking tape of claim 10 wherein the silicone pressure sensitive adhesive comprises a silicone oil.

14. The masking tape of claim 13 wherein the silicone oil comprises a polydiorganosiloxane fluid.

15. The masking tape of claim 13 wherein the rubber-based pressure sensitive adhesive comprises greater than 3 wt-%, and up to 25 wt-% silicone oil, based on the total weight of the pressure sensitive adhesive.

16. (canceled)

17. (canceled)

18. The masking tape of claim 1 wherein the rubber-based pressure sensitive adhesive is a polyisobutylene rubber pressure sensitive adhesive.

19. (canceled)

20. (canceled)

21. A method of anodizing an aluminum surface, the method comprising:
providing a substrate having an aluminum surface;
applying a masking tape of claim 1 to mask the aluminum surface and form a masked substrate; and
exposing the masked substrate to an electrolyte solution comprising chromic acid under conditions effective to form aluminum oxide.

22. The method of claim 21 wherein prior to applying the masking tape, the method further comprises cleaning the aluminum surface prior to applying the masking tape.

23. The method of claim 22 wherein after cleaning and prior to applying the masking tape, the method further comprises applying a conversion coating on the aluminum surface.

24. A method of anodizing an aluminum surface, the method comprising:
providing a substrate having an aluminum surface;
applying a masking tape of any one of the preceding claims to mask the aluminum surface and form a masked substrate; and
exposing the masked substrate to an electrolyte solution comprising chromic acid under conditions effective to form aluminum oxide;
wherein the masking tape comprises:
a flexible backing layer having two major surfaces, wherein the backing layer has a thickness of greater than 64 micrometers and up to 200 micrometers, and one major surface of the backing layer comprises a primed surface; and
a rubber-based pressure sensitive adhesive layer disposed on the primed surface of the backing layer, wherein the pressure sensitive adhesive layer has a thickness of at least 7.6 micrometers;
wherein, when disposed on an aluminum substrate, the masking tape displays a peel adhesion of less than 50 oz/in (547 N/m) according to a Peel Adhesion Strength Test, and a leakage distance of less than 762 micrometers according to a Chromic Acid Anodization—Leakage Distance Test.
